(19) United States
(12) Patent Application Publication
(10) Pub. No.: US 2026/0020585 A1
(43) Pub. Date: Jan. 22, 2026

(54) IMPROVING THE MOUTHFEEL OF PLANT PROTEIN COMPOSITION

(71) Applicant: Firmenich SA, Satigny (CH)

(72) Inventors: Qiu-Min MA, Shanghai (CN); Yongtao WU, Shanghai (CN); Wen-Hao LI, Shanghai (CN); Dan-Ting YIN, Shanghai (CN)

(73) Assignee: Firmenich SA, Satigny (CH)

(21) Appl. No.: 18/997,275

(22) PCT Filed: Aug. 3, 2023
(86) PCT No.: PCT/EP2023/071609

§ 371 Date: Jan. 21, 2025

(30) Foreign Application Priority Data
Aug. 10, 2022 (WO) PCT/CN2022/111379
Sep. 19, 2022 (EP) 22196414.1

(51) Int. Cl. A23J 3/16; A23C 11/10

(52) U.S. Cl. CPC A23J 3/16; A23C 11/103

(57) ABSTRACT

A plant protein composition with improved mouthfeel is described in the present disclosure. The plant protein composition includes a non-polar phase comprising a vegetable oil and/or a medium-chain fatty acid; a polar phase comprising a hydrocolloid; and a surfactant system comprising a plant protein. The hydrocolloid is selected from the group consisting of gum arabic, yam powder, carrageenan, xanthan gum, gellan gum, and any mixture thereof. The hydrocolloid may be present in an amount of 0.1-2.0 wt %. The polar phase further comprises a sugar alcohol or a sugar. A method for preparing the plant protein composition is also described in the present disclosure.

### TECHNICAL FIELD

The present invention generally relates to a plant protein composition. Specifically, the present invention relates to a plant protein composition with improved mouthfeel and a method for manufacturing the plant protein composition.

### BACKGROUND OF THE INVENTION

The benefits of plant-based protein include increased fiber intake, lower risk of cardiovascular disease and some types of cancers, and benefits for weight management. In recent years, plant proteins have been widely explored to replace animal proteins to develop foods products such as milk analogs. However, plant protein beverage has not been appealing to consumers due to mouthfeel and flavor issues. For example, plant protein beverage made from leguminous plants, such as soy or pea, display a typical mouthfeel of watery or lack of thickness compared to pure milk. There is a great need in the industry to develop plant protein beverages with improved mouthfeel.

### BRIEF SUMMARY OF THE INVENTION

In one aspect of the present invention, a plant protein composition is developed. According to some embodiments of the present invention, the plant protein composition may include a non-polar phase comprising a vegetable oil and/or a medium-chain fatty acid; a polar phase comprising a hydrocolloid; and a surfactant system comprising a plant protein.

According to some embodiments of the present invention, the non-polar phase comprises the vegetable oil selected from the group consisting of: sunflower oil, coconut oil, soya oil, castor oil, canola oil, peanut oil, sesame oil, olive oil, rapeseed oil, and any mixture thereof.

According to some embodiments of the present invention, the non-polar phase comprises the medium-chain fatty acid, wherein the medium-chain fatty acid comprises a caprylic/capric triglyceride.

According to some embodiments of the present invention, the non-polar phase further comprises lecithin.

According to some embodiments of the present invention, the lecithin is present in an amount of 0.05-2.0 wt %.

According to some embodiments of the present invention, the hydrocolloid is selected from the group consisting of gum arabic, yam powder, carrageenan, xanthan gum, gellan gum, and any mixture thereof.

According to some embodiments of the present invention, the plant protein comprises one or more proteins selected from the group consisting of: soybean protein, chickpea protein, lentil protein, lupin protein, pea protein, oat protein, potato protein, rice protein, and any mixture thereof.

According to some embodiments of the present invention, the polar phase further comprises a sugar alcohol, wherein the sugar alcohol is selected from the group consisting of: erythritol, xylitol, lactitol, maltitol, mannitol, sorbitol, tagatose, trehalose, galactose, rhamnose, cyclodextrin, ribulose, threose, arabinose, xylose, and any mixture thereof.

According to some embodiments of the present invention, the sugar alcohol is present in an amount of 1.0-10 wt %.

According to some embodiments of the present invention, the polar phase further comprises a sugar, wherein the sugar is selected from the group consisting of: glucose, fructose, galactose, sucrose, lactose, maltose, and any mixture thereof.

According to some embodiments of the present invention, the sugar is present in an amount of 1.0-10 wt %.

According to some embodiments of the present invention, the non-polar phase is present in an amount of 1.0-10 wt %.

According to some embodiments of the present invention, the hydrocolloid is present in an amount of 0.1-2.0 wt %.

According to some embodiments of the present invention, the plant protein is present in an amount of 1.0-5.0 wt %.

In another aspect of the present invention, a method for preparing a plant protein composition is developed. According to some embodiments of the present invention, the method includes mixing a surfactant system and a polar phase to form a first mixture, wherein the surfactant system comprises a plant protein, and the polar phase comprises a hydrocolloid; subjecting the first mixture to heat treatment at a first predetermined temperature for a first period of time; mixing a non-polar phase and the first mixture to form a second mixture, wherein the non-polar phase comprises a vegetable oil and/or a medium-chain fatty acid; pre-emulsifying the second mixture using a high-speed homogenizer; homogenizing the resulted pre-emulsion at a predetermined pressure for predetermined times using a 2-stage high-pressure homogenizer.

According to some embodiments of the present invention, pre-emulsifying the second mixture using the high-speed homogenizer is performed at a speed of 10,000 rpm for 5 minutes.

According to some embodiments of the present invention, the first predetermined temperature comprises 30° C.-70° C., preferably 40° C.-60° C., more preferably 50° C.

According to some embodiments of the present invention, the method further comprises: subjecting the second mixture to a heat treatment under a second predetermined temperature for a second period of time.

According to some embodiments of the present invention, the second predetermined temperature comprises 50° C.-90° C., preferably 60° C.-80° C., more preferably 70° C.

According to some embodiments of the present invention, the second period of time comprises 5-20 minutes, preferably 8-15 minutes, preferably 9-12 minutes, more preferably 10 minutes.

According to some embodiments of the present invention, wherein the predetermined pressure comprises 160/40 bar, preferably 200/50 bar, more preferably 250/50 bar.

According to some embodiments of the present invention, the predetermined times comprise 2 times, 3 times, 4 times, or 5 times.

In another aspect of the present invention, a use of a hydrocolloid as defined in one aspect of the present invention as discussed above for improving the mouthfeel of a plant protein composition is developed.

In another aspect of the present invention, a use of a hydrocolloid as defined in one aspect of the present invention as discussed above for improving the stability of a plant protein composition is developed.

Numerous benefits are achieved by way of the present invention over conventional techniques. For example, some embodiments of the present invention provide a plant protein composition including gum arabic or yam powder. The plant protein composition have better mouthfeel compared with conventional plant protein beverages. Additionally, the plant protein composition according to some embodiments of the present invention tastes more like pure milk, having similar mouthfeel perceptions with respect to thickness, watery, smoothness, and powdery. These and other embodiments of the present invention along with many of its advantages and features are described in more detail in conjunction with the text below and attached figures.

### DETAILED DESCRIPTION OF THE INVENTION

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All dosage ranges contained within this application are intended to include all numbers, whole or fractions, contained within said range. All percentages expressed herein are by weight of the total weight of the beverage composition unless expressed otherwise. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a milk”, “a method”, or “a food” includes a plurality of such “milks”, “methods”, or “foods”. Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive. As used herein, “about” is understood to refer to numbers in a range of numerals.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

As used herein, “wt %” means percentage by weight as understood by a person of ordinary skill in the art.

In one aspect of the present disclosure, a plant protein composition is developed. In some embodiments, the plant protein composition may include a non-polar phase, a polar phase, and a surfactant system. In some embodiments, the non-polar phase may include a vegetable oil and/or a medium-chain fatty acid. In some embodiments, the polar phase may include a hydrocolloid. In some embodiments, the surfactant system may include a plant protein.

In some embodiments, the plant protein may include a single plant protein. In another embodiment, the plant protein may be a blend including two or more plant proteins. The term “plant protein,” as used herein, refers to proteins derived directly or indirectly from plants. For example, the plant protein used in the present disclosure may be selected from legume proteins, whole grain proteins, and wheat proteins. The legume proteins generally include a protein derived from soybean, chickpea, lentil, lupin, pea, or any combination thereof. The whole grain proteins generally include proteins derived from rice or oat.

In one embodiment, the plant protein component may include soybean protein in an amount of from about 0.1 wt % to about 20 wt % of the plant protein composition. Preferably, soybean protein may be present in an amount of from about 0.5 wt % to about 15 wt % of the plant protein composition. More preferably, soybean protein may be present in an amount of from about 1.0 wt % to about 5.0 wt % of the plant protein composition. In one preferable embodiment, the plant protein composition may include about 3.0 wt % soybean protein. It should be noted that soybean protein is used as an exemplary plant protein to illustrate the present invention, and that the present invention is by no means to be limited to soybean protein.

In some embodiments, the hydrocolloid may be selected from gum arabic, yam powder, carrageenan, xanthan gum, gellan gum, or any mixture thereof. The yam powder described herein is a powder of the edible tubers of Dioscorea polystachya or Chinese yam. The powder maybe prepared by spray drying or other methods. In some embodiments, the hydrocolloid may include gum arabic or yam powder. In one embodiment, the hydrocolloid may be present in an amount of from about 0.05 wt % to about 5.0 wt % of the plant protein composition. Preferably, the hydrocolloid may be present in an amount of from about 0.08 wt % to about 3.0 wt % of the plant protein composition. More preferably, the hydrocolloid may be present in an amount of from 0.1% wt % to about 2.0 wt % of the plant protein composition. More preferably, the hydrocolloid may be present in an amount of from 0.3 wt % to about 1.5 wt % of the plant protein composition. More preferably, the hydrocolloid may be present in an amount of from 0.5 wt % to about 1.2 wt % of the plant protein composition. In one preferable embodiment, the plant protein composition may include gum arabic or yam powder in an amount of about 1.0 wt %.

In some embodiments, the non-polar phase may include vegetable oil, such as sunflower oil, coconut oil, soya oil, castor oil, canola oil, peanut oil, sesame oil, olive oil, rapeseed oil, or any mixture thereof. In some embodiments, the non-polar phase may include medium-chain fatty acid, such as caprylic/capric triglyceride. In some embodiments, the non-polar phase may include vegetable oil and medium-chain fatty acid. In some embodiments, the non-polar phase may be present in an amount of from about 1.0 wt % to about 10 wt % of the plant protein composition. Preferably, the non-polar phase may be present in an amount of from about 2.0 wt % to about 8.0 wt % of the plant protein compositions. More preferably, the non-polar phase may be present in an amount of about 3.0 wt % to about 5.0 wt % of the plant protein composition. In one preferable embodiment, the plant protein composition may include vegetable oil in an amount of about 4.0 wt %. In another preferable embodiments, the plant protein composition may include medium-chain fatty acid in an amount of about 4.0 wt %. In another preferable embodiments, the plant protein composition may include a mixture of vegetable oil and medium-chain fatty acid in an amount of about 4.0 wt %.

In some embodiments, the polar phase may further include a sweetener, such as sugars or sugar alcohols. As used herein, sugar may include simple sugars, such as glucose, fructose, and galactose; and compound sugars, such as sucrose, lactose, and maltose. As used herein, sugar alcohols may include erythritol, xylitol, lactitol, maltitol, mannitol, sorbitol, tagatose, trehalose, galactose, rhamnose, cyclodextrin, ribulose, threose, arabinose, xylose, and any mixture thereof. For the purpose of clarity of description, the blow description uses lactose as a non-limiting example of sweetener. It should be noted that other sugars or sugar alcohols are equally applied to the below descriptions. In some embodiments, lactose may be present in an amount of from about 1.0 wt % to about 15 wt % of the plant protein composition. Preferably, lactose may be present in an amount of from about 2.0 wt % to about 10 wt % of the plant protein composition. More preferably, lactose may be present in an amount of from about 3.0 wt % to about 7.0 wt % of the plant protein composition. More preferably, lactose may be present in an amount of from about 4.0 wt % to about 6.0 wt % of the plant protein composition. In one preferable embodiment, the plant protein composition may include lactose in an amount of about 5.0 wt %.

In some embodiments, the surfactant system of the plant protein composition may further include emulsifying agents. In some embodiments, the emulsifying agents are water soluble. Exemplary and suitable emulsifying agents include lecithin, soy polysaccharide, gum acacia, modified starch, carboxymethylcellulose, gum tragacanth, gum ghatti and other suitable gums. For the purpose of clarity of description, the below description use lecithin as a non-limiting example of emulsifying agents. It should be noted that other emulsifying agents are equally applied to the below descriptions. In some embodiments, lecithin may be present in an amount of from about 0.05 wt % to about 2.0 wt % of the plant protein composition. Preferably, lecithin may be present in an amount of from about 0.08 wt % to about 1.5 wt % of the plant protein composition. More preferably, lecithin may be present in an amount of from about 0.1 wt % to about 1.0 wt % of the plant protein composition. More preferably, lecithin may be present in an amount of from about 0.12 wt % to about 0.5 wt % of the plant protein composition. In one preferable embodiment, the plant protein composition may include lecithin in an amount of 0.15 wt %. In some embodiments, emulsifying agents such as lecithin may improve the body of the plant protein composition. Emulsifying agents such as lecithin may also be used to modulate the thickness of the plant protein composition.

The invented plant protein composition may further include food-grade solvents, antioxidants, preservatives, and other hydrophobic ingredients including but not limited to oil-soluble pharmaceutical ingredients, oil-soluble nutraceutical ingredients (e.g., oil-soluble vitamins), oil-soluble colorants, oil-soluble antimicrobial ingredients, oil-soluble defoamers, mouthfeel modulators, or taste modulators. In some embodiments, the polar phase of the plant protein composition may further include additional ingredients, including any of those typically found in milk beverage formulations. Examples of such additional ingredients include, but are not limited to, caramel and other coloring agents or dyes, foaming or antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B (thiamine), B2 (riboflavin), B6, B12, K, niacin, folic acid, biotin, and combinations thereof. Examples of mineral supplements may include calcium, magnesium, zin, potassium, and combination thereof.

In some embodiments, the polar phase of the plant protein composition may include preservatives. As used herein, preservatives include any suitable preservatives approved for use in beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and combinations thereof. Preservatives may be used in amounts not exceeding mandated maximum levels under applicable laws and regulations.

In another aspect of the present invention, a method for preparing a plant protein composition described above is developed. In some embodiments, the method may include mixing the surfactant system and the polar phase to form a first mixture. As described above, the surfactant system may include the plant protein, and the polar phase may include the hydrocolloid.

Then the method may include subjecting the first mixture to heat treatment at a first predetermined temperature for a first period of time. In some embodiments, the surfactant system may include any plant protein as discussed above, which may be present in any suitable amount as discussed above. In some embodiments, as discussed above, the hydrocolloid may be selected from gum arabic, yam powder, carrageenan, xanthan gum, gellan gum, or any mixture thereof. As discussed above, the hydrocolloid may be present in any suitable amount as discussed above. For example, the hydrocolloid may include gum arabic or yam powder. In one embodiment, the hydrocolloid may be present in an amount of from about 0.05 wt % to about 5.0 wt % of the plant protein composition. Preferably, the hydrocolloid may be present in an amount of from about 0.08 wt % to about 3.0 wt % of the plant protein composition. More preferably, the hydrocolloid may be present in an amount of from 0.1% wt % to about 2.0 wt % of the plant protein composition. More preferably, the hydrocolloid may be present in an amount of from 0.3 wt % to about 1.5 wt % of the plant protein composition. More preferably, the hydrocolloid may be present in an amount of from 0.5 wt % to about 1.2 wt % of the plant protein composition. In one preferable embodiment, the plant protein composition may include gum arabic or yam powder in an amount of about 1.0 wt %.

In some embodiments, the polar phase may further include a sweetener, such as sugars or sugar alcohols, as discussed above. For example, the polar phase may include lactose, which may be present in an amount of from about 1.0 wt % to about 15 wt % of the plant protein composition. Preferably, lactose may be present in an amount of from about 2.0 wt % to about 10 wt % of the plant protein composition. More preferably, lactose may be present in an amount of from about 3.0 wt % to about 7.0 wt % of the plant protein composition. More preferably, lactose may be present in an amount of from about 4.0 wt % to about 6.0 wt % of the plant protein composition. In one preferable embodiment, the plant protein composition may include lactose in an amount of about 5.0 wt %.

In some embodiments, the surfactant system of the plant protein composition may further include emulsifying agents, as discussed above. For example, the surfactant system may include lecithin, which may be present in an amount of from about 0.05 wt % to about 2.0 wt % of the plant protein composition. Preferably, lecithin may be present in an amount of from about 0.08 wt % to about 1.5 wt % of the plant protein composition. More preferably, lecithin may be present in an amount of from about 0.1 wt % to about 1.0 wt % of the plant protein composition. More preferably, lecithin may be present in an amount of from about 0.12 wt % to about 0.5 wt % of the plant protein composition. In one preferable embodiment, the plant protein composition may include lecithin in an amount of 0.15 wt %.

In some embodiments, the invented plant protein composition may further include food-grade solvents, antioxidants, preservatives, and other hydrophobic ingredients, as discussed above.

In some embodiments, the first predetermined temperature may be 30° C.-70° C., preferably 40° C.-60° C. More preferably, the first predetermined temperature may be 50° C. In some embodiments, the first period of time for heat treatment may be 20-40 minutes. Preferably, the first period of time for heat treatment may be 30 minutes. In one embodiment, the first mixture is subject to heat treatment at temperature of 50° C. for 30 minutes.

Then, the method may include mixing the non-polar phase and the first mixture to form a second mixture. In some embodiments, the non-polar phase may include vegetable oil and/or medium-chain fatty acid, as discussed above. In some embodiments, the non-polar phase may include vegetable oil, such as sunflower oil, coconut oil, soya oil, castor oil, canola oil, peanut oil, sesame oil, olive oil, rapeseed oil, or any mixture thereof. In some embodiments, the non-polar phase may include medium-chain fatty acid, such as caprylic/capric triglyceride. In some embodiments, the non-polar phase may include vegetable oil and medium-chain fatty acid. In some embodiments, the non-polar phase may be present in any suitable amount, as discussed above. For example, the non-polar phase may include sunflower oil, which may be present in an amount of from about 1.0 wt % to about 10 wt % of the plant protein composition. Preferably, sunflower oil may be present in an amount of from about 2.0 wt % to about 8.0 wt % of the plant protein compositions. More preferably, sunflower oil may be present in an amount of about 3.0 wt % to about 6.0 wt % of the plant protein composition. In one preferable embodiment, the plant protein composition may include sunflower oil in an amount of about 4.0 wt %. In another preferable embodiment, the plant protein composition may include medium-chain fatty acid in an amount of about 4.0 wt %. In another preferable embodiment, the plant protein composition may include a mixture of vegetable oil and medium-chain fatty acid in an amount of about 4.0 wt %.

Next, the method may include subjecting the second mixture to heat treatment at a second predetermined temperature for a second period of time. In some embodiments, the second predetermined temperature may be from about 50° C. to about 90° C., preferably from about 60° C. to about 80° C., more preferably 70° C. In some embodiment, the second period of time may be from about 5 minutes to about 20 minutes, preferably from about 8 minutes to about 15 minutes, more preferably from about 9 minutes to about 12 minutes, and more preferably 10 minutes. In one embodiment, the second mixture is subject to heat treatment at a temperature of 70° C. for 10 minutes.

Next, the method may further include pre-emulsifying the second mixture using a high-speed homogenizer at a speed of 10,000 rpm for 5 minutes. For example, the high-speed homogenizer may be a T25 Digital Ultra Turrax® (IKA®, Germany). Then the method may further include homogenizing the resulted pre-emulsion at a predetermined pressure for predetermined times using a 2-stage high-pressure homogenizer. For example, the high-pressure homogenizer may be a APV-1000 lab homogenizer (SPXFLOW®, US). In some embodiments, the predetermined pressure may be 160/40 bar. In some embodiments, the predetermined pressure may be 200/50 bar, preferably 250/50 bar, more preferably 300/50 bar. In some embodiments, the predetermined times may be 2 times. In some embodiments, homogenization may be performed for 3 times, 4 times, 5 times, or more times as appropriate as the particular application requires.

### EXAMPLES

The present invention is illustrated further herein by the following non-limiting examples.

### Example A

In Example A, a plant protein composition includes: 4.0 wt % sunflower oil, 0.15 wt % lecithin, 3.0 wt % soybean protein, 5.0 wt % lactose, and water quantity sufficient to 100 wt %. The ingredients and their respective percentage by weight in Example A is shown in below Table 1.

TABLE 1

| Ingredient | wt % of final composition |
|---|---|
| Sunflower Oil | 4.0 |
| Lecithin | 0.15 |
| Soybean Protein | 3.0 |
| Lactose | 5.0 |
| Water | 87.85 |

### Example B

In Example B, a plant protein composition includes: 4.0 wt % sunflower oil, 0.15 wt % lecithin, 3.0 wt % soybean protein, 5.0 wt % lactose, 1.0 wt % gum arabic, and water quantity sufficient to 100 wt %. The ingredients and their respective percentage by weight in Example B is shown in below Table 2.

TABLE 2

| Ingredient | wt % of final composition |
|---|---|
| Sunflower Oil | 4.0 |
| Lecithin | 0.15 |
| Soybean Protein | 3.0 |
| Lactose | 5.0 |
| Gum Arabic | 1.0 |
| Water | 86.85 |

### Example C

In Example C, a plant protein composition includes: 4.0 wt % sunflower oil, 0.15 wt % lecithin, 3.0 wt % soybean protein, 5.0 wt % lactose, 1.0 wt % yum powder, and water quantity sufficient to 100 wt %. The ingredients and their respective percentage by weight in Example C is shown in below Table 3.

TABLE 3

| Ingredient | wt % of final composition |
|---|---|
| Sunflower Oil | 4.0 |
| Lecithin | 0.15 |
| Soybean Protein | 3.0 |
| Lactose | 5.0 |
| Yum Powder | 1.0 |
| Water | 86.85 |

### Example D

In Example D, a plant protein composition includes: 4.0 wt % sunflower oil, 0.15 wt % lecithin, 3.0 wt % soybean protein, 5.0 wt % lactose, 1.0 wt % pectin, and water quantity sufficient to 100 wt %. The ingredients and their respective percentage by weight in Example D is shown in below Table 4.

TABLE 4

| Ingredient | wt % of final composition |
|---|---|
| Sunflower Oil | 4.0 |
| Lecithin | 0.15 |
| Soybean Protein | 3.0 |
| Lactose | 5.0 |
| Pectin | 1.0 |
| Water | 86.85 |

### Example E

In Example E, a plant protein composition includes: 4.0 wt % sunflower oil, 0.15 wt % lecithin, 3.0 wt % soybean protein, 5.0 wt % lactose, 1.0 wt % soluble soy polysaccharide, and water quantity sufficient to 100 wt %. The ingredients and their respective percentages by weight in Example E is shown in below Table 5.

TABLE 5

| Ingredient | wt % of final composition |
|---|---|
| Sunflower Oil | 4.0 |
| Lecithin | 0.15 |
| Soybean Protein | 3.0 |
| Lactose | 5.0 |
| Soluble Soy Polysaccharide | 1.0 |
| Water | 86.85 |

### Example F

In Example F, a plant protein composition includes: 4.0 wt % sunflower oil, 0.15 wt % lecithin, 3.0 wt % soybean protein, 5.0 wt % lactose, 1.0 wt % xanthan gum, and water quantity sufficient to 100 wt %. The ingredients and their respective percentages by weight in Example F is shown in below Table 6.

TABLE 6

| Ingredient | wt % of final composition |
|---|---|
| Sunflower Oil | 4.0 |
| Lecithin | 0.15 |
| Soybean Protein | 3.0 |
| Lactose | 5.0 |
| Xanthan Gum | 1.0 |
| Water | 86.85 |

### Example G

In Example G, a plant protein composition includes: 4.0 wt % sunflower oil, 0.15 wt % lecithin, 3.0 wt % soybean protein, 5.0 wt % lactose, 1.0 wt % carrageenan, and water quantity sufficient to 100 wt %. The ingredients and their respective percentage by weight in Example G is shown in below Table 7.

TABLE 7

| Ingredient | wt % of final composition |
|---|---|
| Sunflower Oil | 4.0 |
| Lecithin | 0.15 |
| Soybean Protein | 3.0 |
| Lactose | 5.0 |
| Carrageenan | 1.0 |
| Water | 86.85 |

### Example H

In Example H, a plant protein composition includes: 4.0 wt % sunflower oil, 0.15 wt % lecithin, 3.0 wt % soybean protein, 5.0 wt % lactose, 1 wt % gellan gum, and water quantity sufficient to 100 wt %. The ingredients and their respective percentages by weight in Example H is shown in below Table 8.

TABLE 8

| Ingredient | wt % of final composition |
|---|---|
| Sunflower Oil | 4.0 |
| Lecithin | 0.15 |
| Soybean Protein | 3.0 |
| Lactose | 5.0 |
| Gellan Gum | 1.0 |
| Water | 86.85 |

### Example I

In Example I, a plant protein composition includes: 4.0 wt % sunflower oil, 0.15 wt % lecithin, 3.0 wt % soybean protein, 5.0 wt % lactose, 0.1 wt % xanthan gum, and water quantity sufficient to 100 wt %. The ingredients and their respective percentage by weight in Example H is shown in below Table 9.

TABLE 9

| Ingredient | wt % of final composition |
|---|---|
| Sunflower Oil | 4.0 |
| Lecithin | 0.15 |
| Soybean Protein | 3.0 |
| Lactose | 5.0 |
| Xanthan Gum | 0.1 |
| Water | 87.75 |

### Example J

In Example J, a plant protein composition includes: 4.0 wt % sunflower oil, 0.15 wt % lecithin, 3.0 wt % soybean protein, 5.0 wt % lactose, 0.1 wt % carrageenan, and water quantity sufficient to 100 wt %. The ingredients and their respective percentage by weight in Example J is shown in below Table 10.

TABLE 10

| Ingredient | wt % of final composition |
|---|---|
| Sunflower Oil | 4.0 |
| Lecithin | 0.15 |
| Soybean Protein | 3.0 |
| Lactose | 5.0 |
| Carrageenan | 0.1 |
| Water | 87.75 |

### Example K

In Example K, a plant protein composition includes: 4.0 wt % sunflower oil, 0.15 wt % lecithin, 3.0 wt % soybean protein, 5.0 wt % lactose, 0.1 wt % gellan gum, and water quantity sufficient to 100 wt %. The ingredients and their respective percentage by weight in Example K is shown in below Table 11.

TABLE 11

| Ingredient | wt % of final composition |
|---|---|
| Sunflower Oil | 4.0 |
| Lecithin | 0.15 |
| Soybean Protein | 3.0 |
| Lactose | 5.0 |
| Gellan gum | 0.1 |
| Water | 87.75 |

### Example L

In Example L, a plant protein composition includes: 4.0 wt % sunflower oil, 0.15 wt % lecithin, 3.0 wt % soybean protein, 2.5 wt % maltitol, 2.5 wt % erythritol, 1.0 wt % yam powder, and water quantity sufficient to 100 wt %. The ingredients and their respective percentage by weight in Example L is shown in below Table 12.

TABLE 12

| Ingredient | wt % of final composition |
|---|---|
| Sunflower Oil | 4.0 |
| Lecithin | 0.15 |
| Soybean Protein | 3.0 |
| Maltitol | 2.5 |
| Erythritol | 2.5 |
| Yam Powder | 1.0 |
| Water | 86.85 |

### Example M

In Example M, a plant protein composition includes: 4.0 wt % sunflower oil, 0.15 wt % lecithin, 3.0 wt % soybean protein, 2.5 wt % maltitol, 2.5 wt % erythritol, 1.0 wt % gum arabic, and water quantity sufficient to 100 wt %. The ingredients and their respective percentage by weight in Example M is shown in below Table 13.

TABLE 13

| Ingredient | wt % of final composition |
|---|---|
| Sunflower Oil | 4.0 |
| Lecithin | 0.15 |
| Soybean Protein | 3.0 |
| Maltitol | 2.5 |
| Erythritol | 2.5 |
| Gam Arabic | 1.0 |
| Water | 86.85 |

### Example N

In Example N, a plant protein composition includes: 4.0 wt % sunflower oil, 0.15 wt % lecithin, 3.0 wt % soybean protein, 1.5 wt % maltitol, 1.5 wt % erythritol, 0.1 wt % carrageenan, and water quantity sufficient to 100 wt %. The ingredients and their respective percentage by weight in Example N is shown in below Table 14.

TABLE 14

| Ingredient | wt % of final composition |
|---|---|
| Sunflower Oil | 4.0 |
| Lecithin | 0.15 |
| Soybean Protein | 3.0 |
| Maltitol | 1.5 |
| Erythritol | 1.5 |
| Carrageenan | 0.1 |
| Water | 89.75 |

### Example O

In Example O, a plant protein composition includes: 4.0 wt % Neobee oil, 0.15 wt % lecithin, 3.0 wt % soybean protein, 2.5 wt % maltitol, 2.5 wt % erythritol, 1.0 wt % gum arabic, and water quantity sufficient to 100 wt %. The ingredients and their respective percentage by weight in Example O is shown in below Table 15.

TABLE 15

| Ingredient | wt % of final composition |
|---|---|
| Neobee Oil | 4.0 |
| Lecithin | 0.15 |
| Soybean Protein | 3.0 |
| Maltitol | 2.5 |
| Erythritol | 2.5 |
| Gum Arabic | 1.0 |
| Water | 86.85 |

### Example P

In Example P, a plant protein composition includes: 4.0 wt % Neobee oil, 3.0 wt % soybean protein, 2.5 wt % maltitol, 2.5 wt % erythritol, 1.0 wt % gum arabic, and water quantity sufficient to 100 wt %. The ingredients and their respective percentage by weight in Example P is shown in below Table 16.

TABLE 16

| Ingredient | wt % of final composition |
|---|---|
| Neobee Oil | 4.0 |
| Soybean Protein | 3.0 |
| Maltitol | 2.5 |
| Erythritol | 2.5 |
| Gum Arabic | 1.0 |
| Water | 87.0 |

### Example Q

In Example Q, a plant protein composition includes: 4.0 wt % Neobee oil, 3.0 wt % soybean protein, 1.5 wt % maltitol, 1.5 wt % erythritol, 1.0 wt % gum arabic, and water quantity sufficient to 100 wt %. The ingredients and their respective percentage by weight in Example Q is shown in below Table 17.

TABLE 17

| Ingredient | wt % of final composition |
|---|---|
| Neobee Oil | 4.0 |
| Soybean Protein | 3.0 |
| Maltitol | 1.5 |
| Erythritol | 1.5 |
| Gum Arabic | 1.0 |
| Water | 89.0 |

The physical stabilities of the above examples have been tested using LumiSizer® Dispersion Analyser (LUM GmbH, Germany). The purpose of the test is to show the stabilities of different examples by accelerating the phase separation through centrifugation. The test is conducted at room temperature 20° C. to 25° C. with a centrifugation speed of 4,000 rpm. The transmission of samples is detected at 870 nm. A total of 800 profiles with an interval of 40 s have been collected. The instability indexes of respective examples calculated based on the change of transmission during centrifugation have been determined. A lower instability index shows that the example has higher stability. As a reference, the stability of commercially available pure milk has been tested. The instability indexes of all examples and pure milk are shown in the below Table 18.

TABLE 18

| Sample | Instability Index |
|---|---|
| Example A | 0.436 |
| Example B | 0.271 |
| Example C | 0.185 |
| Example D | 0.132 |
| Example E | 0.493 |
| Example F | <0.001 |
| Example G | <0.001 |
| Example H | <0.001 |
| Example I | 0.700 |
| Example J | 0.154 |
| Example K | 0.771 |
| Example L | 0.244 |
| Example M | 0.198 |
| Example N | 0.180 |
| Example O | 0.062 |
| Example P | 0.131 |
| Example Q | 0.130 |
| Pure milk | 0.138 |

As described above, the difference between Example A and Examples B and C is Example B includes gum arabic and Example C includes yam powder. As shown in Table 18 above, the stability of the plant protein composition with gum arabic or yam powder has been significantly increased. In addition, both the plant protein compositions with gum arabic and the plant protein compositions with yam powder display better stability than pure milk. The stability of Examples L and M also reinforce the above conclusion.

Sensory evaluation of the mouthfeel perception of different examples has been performed with a group of panelists. This evaluation asks the panelists to describe their mouthfeel perception of each example with respect to pure milk. The perception of the panel to each example has been shown in the below Table 19.

TABLE 19

| Sample | Mouthfeel Description |
|---|---|
| Example A | Watery |
| Example B | Good |
| Example C | Good |
| Example D | Offnote |
| Example E | Watery |
| Example F | Too Thick |
| Example G | Too Thick |
| Example H | Too Thick |
| Example I | Thick |
| Example J | Ordinary |
| Example K | Thick |
| Example L | Good |
| Example M | Good |
| Example N | Good |
| Example O | Good |
| Example P | Good |
| Example Q | Good |

As shown in above Table 19, the sensory evaluation panel's description of the mouthfeel of plant protein composition with gum arabic or yam powder are good.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, it should be understood that the method steps described herein are exemplary, and upon reading the present disclosure, a skilled person would understand that one or more method steps described herein can be combined, omitted, re-ordered, or substituted.

As used herein, examples of “about” and “approximately” include a specified value or characteristic to within plus or minus 15, 10, 5, 4, 3, 2, or 1% of the specified value or characteristic. As used herein, examples using the term “between” include end points. For example, a range between 1 and 5 include 1 and 5 along with all other values greater than 1 and less than 5.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-14. (canceled)

15. A method for preparing a plant protein composition, comprising:
mixing a surfactant system and a polar phase to form a first mixture, wherein the surfactant system comprises a plant protein, and the polar phase comprises a hydrocolloid;
subjecting the first mixture to heat treatment at a first predetermined temperature for a first period of time;
mixing a non-polar phase and the first mixture to form a second mixture, wherein the non-polar phase comprises a vegetable oil or a medium-chain fatty acid;
pre-emulsifying the second mixture using a high-speed homogenizer; and
homogenizing the resulted pre-emulsion at a predetermined pressure for predetermined times using a 2-stage high-pressure homogenizer.

16. The method of claim 15, wherein the non-polar phase comprises the vegetable oil selected from the group consisting of: sunflower oil, coconut oil, soya oil, castor oil, canola oil, peanut oil, sesame oil, olive oil, rapeseed oil, and any mixture thereof.

17. The method of claim 15, wherein the non-polar phase comprises the medium-chain fatty acid, wherein the medium-chain fatty acid comprises a caprylic triglyceride or a capric triglyceride.

18. The method of claim 15, wherein the non-polar phase further comprises lecithin.

19. The method of claim 18, wherein the lecithin is present in an amount of 0.05-2.0 wt %.

20. The method of claim 15, wherein the hydrocolloid is selected from the group consisting of gum arabic, yam powder, carrageenan, xanthan gum, gellan gum, and any mixture thereof.

21. The method of claim 15, wherein the plant protein comprises one or more proteins selected from the group consisting of: soybean protein, chickpea protein, lentil protein, lupin protein, pea protein, oat protein, potato protein, rice protein, and any mixture thereof.

22. The method of claim 15, wherein the polar phase further comprises a sugar alcohol, wherein the sugar alcohol is selected from the group consisting of: erythritol, xylitol, lactitol, maltitol, mannitol, sorbitol, tagatose, trehalose, galactose, rhamnose, cyclodextrin, ribulose, threose, arabinose, xylose, and any mixture thereof.

23. The method of claim 22, wherein the sugar alcohol is present in an amount of 1.0-10 wt %.

24. The method of claim 15, wherein the polar phase further comprises a sugar, wherein the sugar is selected from the group consisting of: glucose, fructose, galactose, sucrose, lactose, maltose, and any mixture thereof.

25. The method of claim 24, wherein the sugar is present in an amount of 1.0-10 wt %.

26. The method of claim 15, wherein the non-polar phase is present in an amount of 1.0-10 wt %.

27. The method of claim 15, wherein the hydrocolloid is present in an amount of 0.1-2.0 wt %.

28. The method of claim 15, wherein the plant protein is present in an amount of 1.0-5.0 wt %.

29. The method of claim 15, wherein pre-emulsifying the second mixture using the high-speed homogenizer is performed at a speed of 10,000 rpm for 5 minutes.

30. The method of claim 15, wherein the first predetermined temperature is 30° C.-70° C.

31. The method of claim 15, wherein the first period of time is 20-40 minutes.

32. The method of claim 15, further comprising:
subjecting the second mixture to a heat treatment under a second predetermined temperature for a second period of time.

33. The method of claim 32, wherein the second predetermined temperature is 50° C.-90° C.

34. The method of claim 32, wherein the second period of time is 5-20 minutes.

35-38. (canceled)
